(19) United States
(12) Patent Application Publication
(10) Pub. No.: US 2011/0076597 A1
(43) Pub. Date: Mar. 31, 2011

(54) WIRE MESH CURRENT COLLECTOR, SOLID STATE ELECTROCHEMICAL DEVICES INCLUDING THE SAME, AND METHODS OF MAKING THE SAME

(75) Inventor: Theodore G. Sutton, Kingston, TN (US)

(73) Assignee: UT-Battelle, LLC, Oak Ridge, TN (US)

(21) Appl. No.: 12/891,345

(22) Filed: Sep. 27, 2010

Related U.S. Application Data
(60) Provisional application No. 61/246,702, filed on Sep. 29, 2009.

(51) Int. Cl. H01M 4/74; H01M 8/00

(52) U.S. Cl. 429/517; 429/535

(57) ABSTRACT

A tubular conductive wire mesh is provided for use in solid state electrochemical devices such as fuel cells. The tubular conductive wire mesh is typically formed from wire using knitting, weaving, or similar process. The mesh typically includes a plurality of substantially uniform interconnected adjacent segments that may form junctions that provide a repetitive pattern of localized bumps that may form preferred electrical contact points between the conductive wire mesh and a surface of a tubular fuel cell body in a solid state electrochemical device. In some embodiments the conductive wire mesh is disposed adjacent the inside surface of a tubular electrode and in some embodiments the conductive wire mesh is disposed adjacent the outside surface of a tubular fuel cell body.

### CROSS-REFERENCE TO RELATED APPLICATIONS

This application claims priority to U.S. Provisional Application No. 61/246,702, entitled “Wire Mesh Current Collector,” filed Sep. 29, 2009, the entirety of which is incorporated by reference herein.

### GOVERNMENT RIGHTS

This invention was made with government support under Contract No. DE-AC05-00OR22725 awarded by the U.S. Department of Energy. The government has certain rights in the invention.

### FIELD OF THE INVENTION

This disclosure relates to the field of solid state electrochemical devices, e.g., fuel cells. More particularly, this disclosure relates to current collectors for electrodes for solid state electrochemical devices.

### BACKGROUND

A solid state electrochemical device or cell comprises two electrodes—the anode and the cathode—and a dense electrolyte membrane which separates the anode and the cathode regions of the cell. For example, fuel cells generally have a fuel electrode (anode) and an oxidant electrode (cathode). In a hydrogen/oxygen fuel cell, hydrogen passes over the anode where it dissociates into protons and electrons. The protons are conducted through the membrane to the cathode, while the electrons are forced to travel in an external circuit, wherein electrical power may be generated. Oxygen is provided at the cathode where it reacts with the electrons that traveled through the external circuit and the protons that were conducted through the membrane to form water, which becomes a generally benign waste discharge product.

The performance of a solid state electrochemical device such as a fuel cell depends at least in part upon the efficiency of the construction that removes electrons from the cathode and distributes the electrons at the cathode. This efficiency depends at least in part upon the uniformity of electrical conductivity across the surface of each electrode. Sometimes when electrical conduction is not uniform, thermal hot spots may form on the electrodes. Such thermal hotspots may damage the electrode. What are needed therefore are improved electron distribution systems for solid state electrochemical devices and improved methods for fabrication of elements for solid state electrochemical devices that will provide a more efficient and uniform distribution of electrons.

### SUMMARY OF THE INVENTION

In one embodiment, the present disclosure provides a tubular conductive wire mesh that includes a conductive wire forming a knit mesh. The knit mesh has a series of adjacent substantially uniform interconnected generally triangular loops, where each generally triangular loop has a base portion and a tip portion. For each generally triangular loop, the conductive wire extends from the tip portion of a generally triangular first loop through the base portion of a longitudinally adjacent generally triangular second loop to form a junction and then forms the base portions of generally triangular third and fourth loops that are laterally adjacent the first loop. Furthermore, the knit mesh has a cylindrical free-state configuration. The tubular conductive wire mesh may be used as a current collector for electrodes for solid state electrochemical devices, such as solid oxide fuel cells.

The present disclosure also provides a non-rigid tubular conductive wire mesh that has a maximum insertion diameter, a minimum envelope diameter, a longitudinal compressive yield strength, and a longitudinal tensile yield strength. Under a longitudinal compressive force that does not exceed the longitudinal compressive strength of the conductive wire mesh, the conductive wire mesh is expandable to an expanded inside diameter that is larger than the maximum insertion diameter, and under a longitudinal tensile force that does not exceed the longitudinal tensile strength of the mesh the conductive wire mesh is contractible to a contracted outside diameter that is less than the minimum envelope diameter.

Methods are provided for fabricating an element for a solid state electrochemical device that incorporates a tubular fuel cell body and a tubular conductive wire mesh disposed adjacent an interior portion of the tubular fuel cell body. Methods are provided for fabricating an element for a solid state electrochemical device that incorporates a tubular fuel cell body and a tubular conductive wire mesh disposed adjacent an exterior portion of the tubular fuel cell body.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a perspective view of a tubular conductive wire mesh for use with an electrode for a solid state electrochemical device.

FIG. 2 is a detailed view of an exemplary knit mesh for use with an electrode for a solid state electrochemical device.

FIG. 3. is a detailed view of an exemplary woven mesh for use with an electrode for a solid state electrochemical device.

FIG. 4 is a cutaway view of a tubular conductive wire mesh electrically coupled to an inside surface of an electrode for a solid state electrochemical device.

FIG. 5 is a view of a tubular conductive wire mesh electrically coupled to an outside surface of an electrode for a solid state electrochemical device.

FIG. 6 is a perspective view of a tubular conductive wire mesh positioned for insertion adjacent an inside surface of an electrode for a solid state electrochemical device, by pushing.

FIG. 7. is a perspective view of a tubular conductive wire mesh positioned for insertion adjacent an inside surface of an electrode for a solid state electrochemical device, by pulling.

FIG. 8 is a cutaway view of a woven mesh and a coil spring electrically coupled to an inside surface of an electrode for a solid state electrochemical device.

FIG. 9 is a cutaway view of a woven mesh and two seating rings electrically coupled to an inside surface of an electrode for a solid state electrochemical device.

FIG. 10 is a cutaway view of a woven mesh and a coil spring electrically coupled to an outside surface of an electrode for a solid state electrochemical device.

FIG. 11 is a cutaway view of a woven mesh and two seating rings electrically coupled to an outside surface of an electrode for a solid state electrochemical device.

FIG. 12 is a perspective view and an end view of an exemplary tubular fuel cell body.

FIG. 13 is a perspective view of an exemplary tubular fuel cell body.

### DETAILED DESCRIPTION

In the following detailed description of the preferred and other embodiments, reference is made to the accompanying drawings, which form a part hereof, and within which are shown by way of illustration the practice of specific embodiments of elements for solid state electrochemical devices comprising a tubular conductive wire mesh. The following detailed description also presents preferred and other embodiments of methods for fabricating elements for solid state electrochemical devices. It is to be understood that other embodiments may be utilized, and that structural changes may be made and processes may vary in other embodiments.

Various embodiments of wire mesh materials that may be used as a current collector in solid state electrochemical devices such as fuel cells are disclosed herein. In some embodiments this mesh material may be inserted into an interior portion of a tubular fuel cell electrode. Various mechanisms may be used, if needed, to expand the mesh material to enhance its electrical contact with an interior surface of the tube. In some embodiments the wire mesh material may be applied to an exterior surface of a tubular fuel cell electrode. In some embodiments, the mesh material may be coupled to the tubular fuel cell electrode by an electrically conductive paste to enhance the electrical contact of the mesh material to the electrode. Wire mesh materials that are installed with individual tubular fuel cell electrodes of a tubular fuel cell array may be interconnected,in either series or parallel configurations.

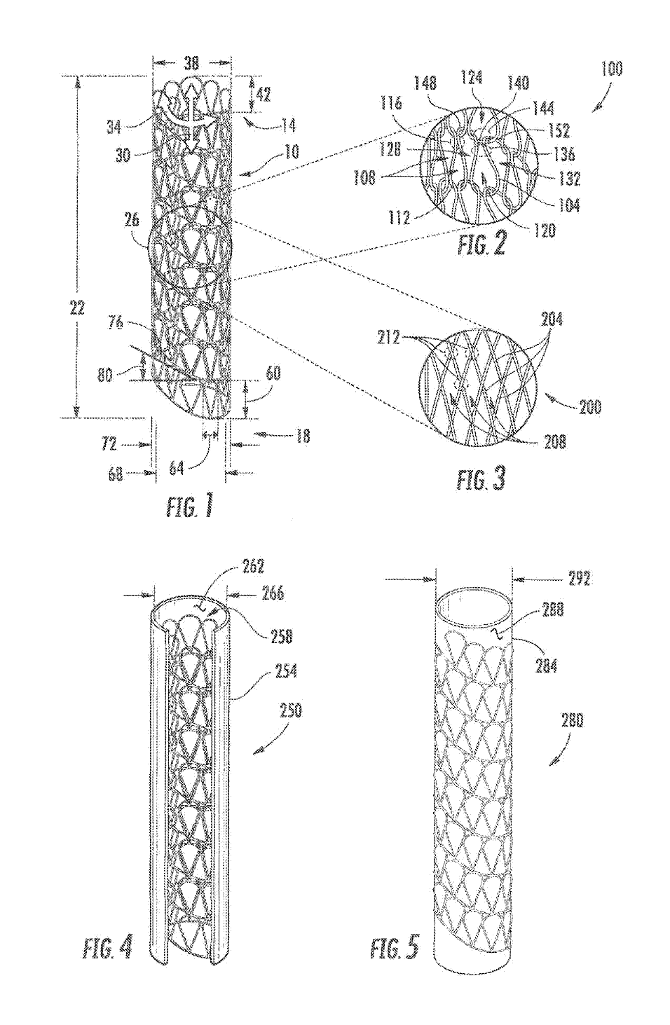

FIG. 1 presents a view of one embodiment of a tubular conductive wire mesh 10 for a fuel cell. The tubular conductive wire mesh 10 has a first end 14, a second end 18, a length 22, and a mesh pattern 26. For referential purposes, a first arrow 30 represents the longitudinal orientation of the mesh pattern 26 and a second arrow 34 represents the circumferential orientation of the mesh pattern 26. In accordance with the disclosure herein, generally the circumferential shape of a tubular conductive wire mesh (e.g., conductive wire mesh 10) is oval, having an elliptical aspect ratio (i.e., a ratio of width 38 over length 42) that may range from 1.0 (substantially circular) to about 1.3. In FIG. 1 the mesh pattern 26 is generalized. FIGS. 2 & 3 illustrate specific embodiments (a knit mesh 100 and a woven mesh, respectively) of the generalized mesh pattern 26.

The knit mesh 100 of FIG. 2 is fabricated from a single conductive wire 104. The knit mesh 100 has a plurality of substantially uniform interconnected loops 108. The substantially uniform interconnected loops 108 are disposed adjacent each other in the longitudinal orientation (as indicated by the first arrow 30 of FIG. 1) and the substantially uniform interconnected loops 108 are disposed adjacent each other in the circumferential orientation (as indicated by the second arrow 34 of FIG. 1). The interconnected loops 108 are generally triangular shaped, with each loop 108 having a base portion 112 and a tip portion 116. Using loops 120, 124, 128, 132 as examples, the conductive wire 104 extends from the tip portion 136 of a generally triangular first loop 120 through the base portion 140 of a longitudinally adjacent generally triangular second loop (loop 124 in this example) to form a junction 144 and then the conductive wire 104 forms the base portions (148 and 152) of generally triangular third and fourth loops (128 and 132) that are laterally adjacent the first loop 120.

Generally triangular loops (e.g., loops 108) typically have a loop aspect ratio (e.g., a ratio of height 60 to base 64 as depicted in FIG. 1) that ranges from about 1 to about 3, with a loop aspect ratio of 2 being typical.

In the example of FIG. 2, the generally triangular loops that are circumferentially adjacent (e.g., loops 128 and 120, loops 120 and 136) are triangularly inverted. That is, the third loop 128 has its tip portion pointed toward the second end 18 whereas the circumferentially adjacent first loop 120 has its tip portion pointed toward the first end 14 and the circumferentially adjacent fourth loop 132 has its tip portion pointed toward the second end 18. When counting loops around the circumference of conductive wire mesh 10, loops 128 and 120 are counted as two loops.

Note that the loops 108 that are disposed at the first end 14 of the conductive wire mesh 10 are “loose loops.” That is, for the generally triangular loops 108 that are disposed at the first end (14 in FIG. 1) of the conductive wire mesh 10, the conductive wire 104 will not extend from the tip portion (e.g., 136) of the generally triangular loops 108 through the base portion (e.g., 140) of a longitudinally adjacent generally triangular loop 108 because at the first end 14 there are no generally triangular loops 108 that extend beyond the tip portions (136) of the generally triangular loops 108 that are disposed at the first end (14 in FIG. 1) of the conductive wire mesh 10.

The junctions 144 form locations on the tubular conductive wire mesh 10 where the conductive wire 104 overlaps itself. These overlaps provide a repetitive pattern of localized bumps. These localized bumps provide slight variations (along the longitudinal direction of the first arrow 30) of the inside diameter 68 and the outside diameter 72 of the tubular conductive wire mesh 10. That is, the outside diameter (e.g., outside diameter 72 of FIG. 1) is typically slightly larger at a junction (e.g., junction 144 of FIG. 2) than the average outside diameter of the overall tubular conductive wire mesh 10. This pattern of localized bumps also provides a localized inside diameter (e.g., inside diameter 68 of FIG. 1) such that the tubular conductive wire mesh 10 has a minimum inside diameter (e.g., the inside diameter 68) that is typically slightly smaller than the average inside diameter of the overall tubular conductive wire mesh 10. These bumps may form preferred electrical contact points when the knit wire mesh 100 is used as a component in an electrode for a solid state electrochemical device.

In the example of FIG. 2 the junctions 144 form a spiral pattern (depicted as spiral pattern 76 in FIG. 1) in the knit mesh 100. Typically a spiral pattern may proceed from one end (e.g. the second end 18) to the other end (e.g. the first end 14) of a conductive wire mesh (e.g., conductive wire mesh 10) at a pitch angle 80 that may vary from about zero degrees to about thirty degrees for different portions of a circumferential path. Not all conductive wire meshes (particularly not all woven meshes) form a spiral pattern of junctions.

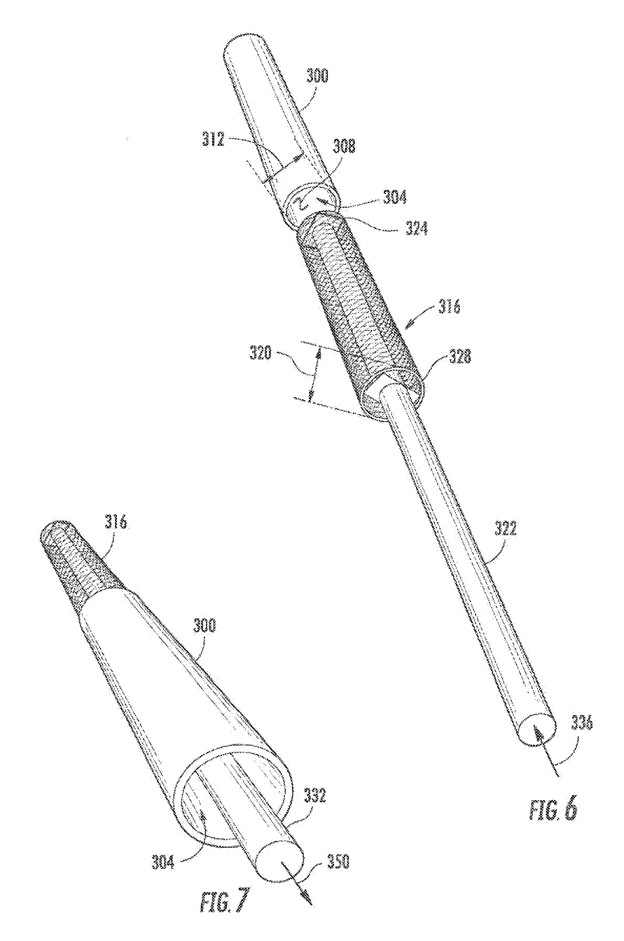

FIG. 3 illustrates a second specific example (a woven mesh 200) of the generalized mesh pattern 26 of FIG. 1. The woven mesh 200 has a plurality of conductive wires 204 that are woven together to form a plurality of cells 208. The conductive wires 204 also form a plurality of junctions 212 where the conductive wires 204 overlap. These overlaps provide a repetitive pattern of localized bumps where a maximum outside diameter (e.g., diameter 72 of FIG. 1) is typically slightly larger than the average diameter of the overall tubular conductive wire mesh 10 and a minimum inside diameter (e.g., inside diameter 68 of FIG. 1) that is slightly less than the average inside diameter of the overall tubular conductive wire mesh 10. As with the bumps formed by the junctions 144 of the knit mesh 100 of FIG. 2, these bumps formed by the junctions 204 of the woven mesh 200 of FIG. 3 may form preferred electrical contact points when the woven mesh 200 is used as a component in an electrode for a solid state electrochemical device.

The loops 108 of the knit mesh 100 of FIG. 2 and the cells 208 of the woven mesh 200 of FIG. 3 are examples of “segments” of a mesh pattern. Other repetitive interlocking patterns may also be used to form a tubular conductive wire mesh (generically-depicted as tubular conductive wire mesh 10 in FIG. 1) that has segments. For example a tubular conductive wire mesh may be formed using a weave similar to that which is used in a chain-link (or “cyclone”) fence. The individual diamond-shaped portions of such a weave pattern are the segments of that tubular conductive wire mesh.

The term “free-state,” as used herein, refers to an environment where a conductive wire mesh (either a knit mesh or a woven mesh) is subject to no external force except gravity. In many embodiments a tubular conductive wire mesh (either a knit mesh or a woven mesh) has a “cylindrical free-state configuration.” A knit mesh or a woven mesh that has a cylindrical free-state configuration (as depicted for the tubular conductive wire mesh 10 of FIG. 1) intrinsically has a generally tubular shape without any external shaping mechanism causing it to have a generally tubular shape. A knit mesh or a woven mesh that has a cylindrical free-state configuration is a conductive wire mesh that does not collapse to a flat tube if placed on its side, and does not collapse into a pile if placed on an end. In contrast, a tubular conductive wire mesh formed using the weave pattern of a chain-link fence will collapse to a flat tube if placed on its side, and therefore such a tubular conductive wire mesh does not have a cylindrical free-state configuration.

For the tubular conductive wire mesh 10 the outside diameter 72 and the inside diameter 68 are free-state diameters, and the length 22 is a free-state length. A tubular conductive wire mesh may be configured to have a cylindrical free-state configuration even if the loops (e.g., the loops 108 of the knit mesh 100 of FIG. 2) or the cells (e.g., the cells 208 of the woven mesh 200 of FIG. 3) of the tubular conductive wire mesh (e.g., 10) are not rigidly interconnected. A rigid interconnection is an interconnection wherein the interconnected pieces cannot be moved relative to each other without breaking a bond (such as a weld or a crimp) formed between the interconnected pieces. Loops and cells that are not rigidly interconnected are referred to herein as “loose segments.” A conductive wire mesh having a cylindrical free-state configuration may be formed using loose segments by using comparatively stiff, resilient wires to form the knit mesh (e.g., 100 of FIG. 2) or to form the woven mesh (e.g., 200 of FIG. 3).

Conductive wire meshes have yield strengths. A yield strength is the maximum force that may be applied to a conductive wire mesh without plastically deforming (e.g., bending) any of the wire(s) used in construction of the mesh to the extent that the wire does not return to its original shape when the force is removed. The term “non-rigid” as used herein refers to a characteristic of an element wherein the element flexes visibly (without magnification of the image) under forces that are applied to the element manually without the application of leveraging forces from tools. In non-rigid embodiments of a conductive wire mesh, when the mesh is constrained to its free-state length, there is a maximum diameter rod that may be inserted inside the mesh without exceeding the yield strength of the mesh. This maximum diameter is referred to herein as the “maximum insertion diameter” of the mesh. In non-rigid embodiments of a conductive wire mesh, when the mesh is constrained to its free-state length, there is a minimum diameter cylinder into which the mesh may placed without exceeding the yield strength of the mesh. This minimum diameter is referred to herein as the “minimum envelope diameter.” In non-rigid embodiments of a conductive wire mesh, when the length of the mesh is not constrained, there is a maximum longitudinal compressive force that may be applied to the mesh without exceeding the yield strength of the mesh. This maximum compressive force is referred to herein as the “longitudinal compressive yield strength” of the mesh. In non-rigid embodiments of a conductive wire mesh, when the length of the mesh is not constrained, there is a maximum longitudinal tensile (i.e., stretching) force that may be applied to the mesh without exceeding the yield strength of the mesh. This maximum tensile force is referred to herein as the “longitudinal tensile yield strength” of the mesh.

In non-rigid examples of a conductive wire mesh, when the knit mesh 100 of FIG. 2 or the woven mesh 200 of FIG. 3 is used to form the tubular conductive wire mesh 10 of FIG. 1, the tubular conductive wire mesh may be configured such that a longitudinal compressive force causes the distance between the segments of the mesh pattern to decrease slightly, and causes the free-state length 22 of the tubular conductive wire mesh 10 to decrease, and causes the outside diameter 72 and the inside diameter 68 of the tubular conductive wire mesh 10 to both increase slightly to expanded inside and outside diameters. The longitudinal compressive force may be applied by combination of (a) a first longitudinal force applied at first end 14 vectored toward the second end 18 and (b) a second longitudinal force applied at the second end 18 vectored toward the first end 14. Such a compressive force may be used to expand the inside diameter of a tubular conductive wire mesh to fit the conductive wire mesh over the outside surface of a tubular fuel cell electrode having an outside diameter that is greater than the maximum insertion diameter of the mesh. If such a conductive wire mesh is positioned inside a tubular fuel cell electrode having an inside diameter that is greater than the minimum envelope diameter of the mesh, such a longitudinal compressive force may be used to press the conductive wire mesh against an inside surface of the tubular fuel cell electrode.

Furthermore, in such non-rigid examples, when the knit mesh 100 of FIG. 2 or the woven mesh 200 of FIG. 3 is used to form the tubular conductive wire mesh 10 of FIG. 1, the tubular conductive wire mesh may be configured such that a longitudinal stretching force causes the distance between the segments of the mesh pattern to increase slightly, and causes the free-state length 22 of the tubular conductive wire mesh 10 to increase, and causes the outside diameter 72 and the inside diameter 68 of the tubular conductive wire mesh 10 to both decrease slightly to constricted (smaller) inside and outside diameters. The longitudinal stretching force may be applied by a combination of (a) a first longitudinal force applied at first end 14 vectored away from the second end 18 and (b) a second longitudinal force applied at the second end 18 vectored away from the first end 14. Such a stretching force may be used to contract the inside diameter of a tubular conductive wire mesh to fit the conductive wire mesh inside a tubular fuel cell electrode having an inside diameter that is less than the minimum envelope diameter of the mesh. Similarly, if such a conductive wire mesh is positioned on the outside of a tubular fuel cell electrode having an outside diameter less than the insertion diameter of the mesh, such a longitudinal tensile force may be used to press the conductive wire mesh against the outside surface of the tubular fuel cell electrode.

In a typical example, when applying a longitudinal compressive force that does not cause the longitudinal compressive strength of the tubular conductive wire mesh to be exceeded, the tubular conductive wire mesh is (a) expandable to an expanded inside diameter that is at least one percent larger than the free-state inside diameter and (b) expandable to an expanded outside diameter that is at least one percent larger than the free-state outside diameter.

FIG. 4 illustrates an element for a solid state electrochemical device 250. The element 250 has a tubular fuel cell body 254 that has an interior portion 258 with an inside surface 262 and an inside diameter 266. A portion of the tubular fuel cell body 254 has been cut away to illustrate that the tubular conductive wire mesh 10 of FIG. 1 is disposed in the interior portion 258 of the tubular fuel cell body 254, adjacent the inside surface 262. The tubular conductive wire mesh 10 can be in electrical contact with tubular fuel cell body 254, an electrode that is part of the tubular fuel cell body, or both.

FIG. 4 is generalized to show only a single layer for the tubular fuel cell body 254, of the solid state electrochemical device 250. However, it should be understood that the tubular fuel cell body 254 can include multiple layers, including, but not limited to, porous support members, electrodes, i.e., anodes and cathodes, and dense electrolytes. Furthermore, it should be understood, that the inside surface 262 of the tubular fuel cell body 254 can be the innermost layer of the tubular fuel cell body 254, e.g., a porous support member or an electrode, such as a porous anode or porous cathode.

As used herein, “tubular fuel cell body” is used to refer to the core elements of a tubular fuel cell, such as an anode, a cathode, a dense solid electrolyte disposed between the anode and the cathode, and any porous support tubes, porous metallic layers, or buffer layers. Exemplary fuel cell bodies include, but are not limited to, those shown in FIGS. 12 & 13, as well as, the fuel cell bodies shown in U.S. Pat. No. 7,785,747, issued Sep. 31, 2010; U.S. Patent Application Publication No. 2007-0141424 published Jun. 21, 2007; U.S. Pat. No. 7,758,993 issued Jul. 20, 2010; U.S. Patent Application Publication No. 2007-0237998 published Oct. 11, 2007; and U.S. Patent Application Publication No. 2008-0254335 published Oct. 16, 2008, the entireties of which are hereby incorporated by reference.

The tubular porous metallic materials, such as support tubes and porous metallic layers, described herein can comprise any porous, sinterable material selected from the group consisting of a non-noble transition metal, metal alloy, and a cermet incorporating one or more of a non-noble transition metal and a non-noble transition metal alloy, preferably a stainless steel, and more preferably a ferritic and/or austenitic stainless steel. Exemplary sinterable materials include Series 300 and 400 stainless steel, including 434L stainless steel powder having a particle size of 25-53 μm. Exemplary support tubes can be of any diameter or length with a wall thickness no greater than about 4 mm, or no greater than 1 mm. In addition, porous support tubes and/or porous metallic layers can have an average pore size in the range of 1 to 30 μm, or 1.5 to 20 μm, or 2 to 15 μm. Moreover, the porous support tubes and/or porous metallic layers should have an average pore volume in the range of 20 to 50 volume percent and should be electrically conductive at all fuel cell operating temperatures.

The anode material can be any anode material including a cermet composition. Examples of suitable cermet compositions include, but are not limited to Ni—YSZ, Ni—GdCeO₂, Ni—SmCeO₂, and Ag—SmCeO₂. The anode thickness can be in a range of 5-70 μm, or 5-60 μm, or 5-50 μm, or 5-40 μm. The anode can have an average pore size of 1-20 μm and pore volume of 25-40 volume percent.

The dense solid electrolyte can be a non-porous and/or essentially fully dense O₂-permeable or H₂-permeable electrolyte composition. Examples of suitable electrolyte compositions include but are not limited to YSZ, GdCeO₂, SmCeO₂, LaSrGaMgO₃, BaCeYO₃, and La₂Mo₂O₉. The electrolyte can have a thickness in a range of 2-80 μm, or 2-70 μm, or 2-60 μm, or 2-50 μm. The electrolyte should be dense and gas tight to prevent the air and fuel from mixing.

The cathode can include an alkaline earth substituted lanthanum manganite, alkaline earth substituted lanthanum ferrite, lanthanum strontium iron cobaltite, or a mixed ionic-electronic conductor. Exemplary cathode materials include doped and undoped oxides or mixtures of oxides in the pervoskite family such as LaMnO₃, LaNiO₃, LaCoO₃, LaCrO₃ and other electronically conducting mixed oxides generally composed of rare earth oxides mixed with oxides of cobalt, nickel, copper, iron, chromium, manganese, and combinations of such oxides. A strontium doped lanthanum manganite material may be used as the cathode material with the preferred cathode material being La₈Sr₂MnO₃. The cathode thickness can be in a range of 5-70 μm, or 5-60 μm, or 5-50 μm, or 5-40 μm. The cathode can have an average pore size of 1-15 μm and pore volume of 25-40 volume percent.

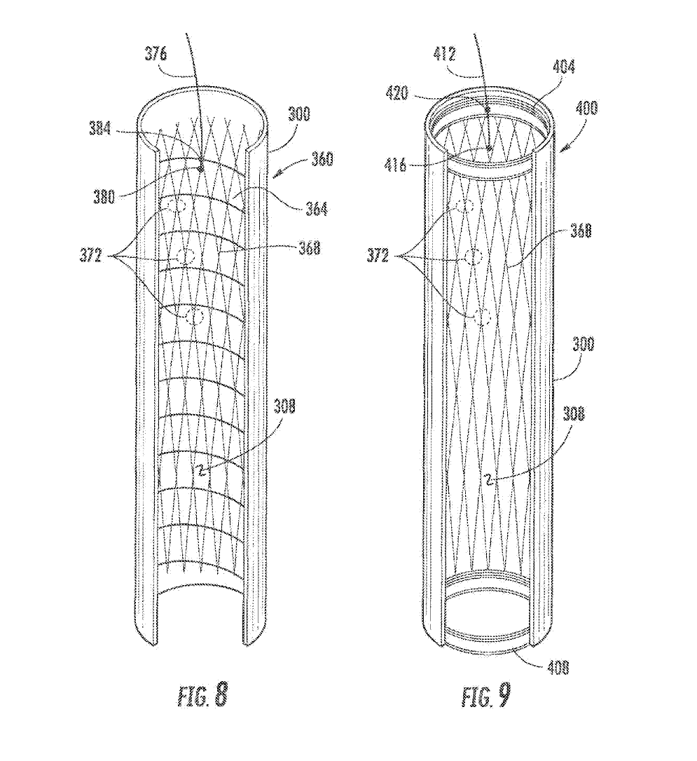

FIG. 5 illustrates an element for a solid state electrochemical device 280. The element 280 has a tubular fuel cell body 284 that has an outside surface 288 and an outside diameter 292. The tubular conductive wire mesh 10 of FIG. 1 is disposed adjacent the outside surface 288 of the tubular fuel cell body 284.

FIG. 5 is generalized to show only a single layer for the tubular fuel cell body 284, of the solid state electrochemical device 280. However, it should be understood that the tubular fuel cell body 284 can include multiple layers, including, but not limited to, porous support members, electrodes, i.e., anodes and cathodes, and dense electrolytes. Furthermore, it should be understood, that the outside surface 288 of the tubular fuel cell body 284 can be the outsidemost layer of the tubular fuel cell body, e.g., a porous support member or an electrode, such as a porous anode or porous cathode. Exemplary fuel cell bodies include, but are not limited to, those shown in FIGS. 12 & 13, as well as, the fuel cell bodies shown in U.S. Pat. No. 7,785,747, issued Sep. 31, 2010; U.S. Patent Application Publication No. 2007-0141424 published Jun. 21, 2007; U.S. Pat. No. 7,758,993 issued Jul. 20, 2010; U.S. Patent Application Publication No. 2007-0237998 published Oct. 11, 2007; and U.S. Patent Application Publication No. 2008-0254335 published Oct. 16, 2008, the entireties of which are hereby incorporated by reference.

In fabricating an element for a solid state electrochemical device, the tubular conductive wire mesh typically has a free-state outside diameter that is not more than about five percent larger than a tubular electrode's inside diameter into which it is inserted and a tubular conductive wire mesh typically has a free-state outside diameter that is not less than about ninety five percent of the outside diameter of a tubular electrode over which it is drawn.

FIG. 6 illustrates an assembly operation for fabricating an element for a solid state electrochemical device that includes a tubular fuel cell body 300 having an interior portion 304 with an inside surface 308 and an inside diameter 312. An inside surface 308 of an exemplary fuel cell body 300 can be a porous support tube, an electrode, such as a porous anode or porous cathode, or any other component of a tubular fuel cell body 300. A tubular conductive wire mesh 316 having the following characteristics has been selected for this application. The tubular conductive wire mesh 316 has a longitudinal tensile yield strength and a plurality of junctions (such as junctions 144 in FIG. 2 or junctions 212 in FIG. 3). Preferably the tubular conductive wire mesh 316 is formed with loose segments and has a cylindrical free-state configuration. In the embodiment of FIG. 6 the tubular conductive wire mesh 316 has been selected to be constrictable to a constricted diameter 320 that is substantially no more than the inside diameter 312 of the tubular fuel cell body 300 by applying to the tubular conductive wire mesh 316 a longitudinal stretching force that is less than the longitudinal tensile yield strength. The longitudinal stretching force may be applied by a first stretcher bar 324 and a second stretcher bar 328 that may be moved apart from each other along a push rod 322 to create the longitudinal stretching force. In some embodiments the constricted diameter 320 may be the free-state diameter of the tubular conductive wire mesh 316, and in such embodiments the longitudinal stretching force may be substantially zero. A longitudinal stretching force is helpful for inserting the tubular conductive wire mesh 316 into the interior portion 304 of the tubular fuel cell body 300 if the free-state diameter of the tubular conductive wire mesh 316 is greater than or equal to the inside diameter 312 of the tubular fuel cell body 300. A longitudinal stretching force is generally needed for inserting the tubular conductive wire mesh 316 into the interior portion 304 of the tubular fuel cell body 300 if the maximum envelope diameter of the tubular conductive wire mesh is greater than the inside diameter of the tubular fuel cell body 300 in order to provide a constricted outside diameter 320 of the tubular conductive wire mesh 316 that is constricted to be less than the inside diameter 312 of the tubular fuel cell body 300.

A further useful criterion for selection of a tubular conductive wire mesh 316 is that the conductive wire mesh is expandable to an expanded diameter that is substantially equal to the inside diameter of the tubular fuel cell body 300 by applying a seating force. If the tubular conductive wire mesh 316 has a cylindrical free-state configuration and if the free state diameter of the tubular conductive wire mesh 316 is greater than the inside diameter 312 of the tubular fuel cell body 300 (such that a longitudinal stretching force has been applied to stretch the tubular wire mesh 316 to provide a constricted outside diameter 320 that is less than the inside diameter 312 of the tubular fuel cell body 300), then the seating force may be applied by a natural resilience of the tubular conductive wire mesh to return to its free state diameter when the stretching force is removed.

A longitudinal assembly pushing force 336 may be applied to the tubular conductive wire mesh to insert the tubular conductive wire mesh 316 into the interior portion 304 of the tubular fuel cell body 300. After the tubular wire mesh 316 is inserted into the interior portion 304 of the tubular fuel cell body 300, the longitudinal stretching force may be removed from the tubular conductive wire mesh (if the longitudinal stretching force was applied) and the longitudinal assembly force 336 may be removed from the tubular conductive wire mesh.

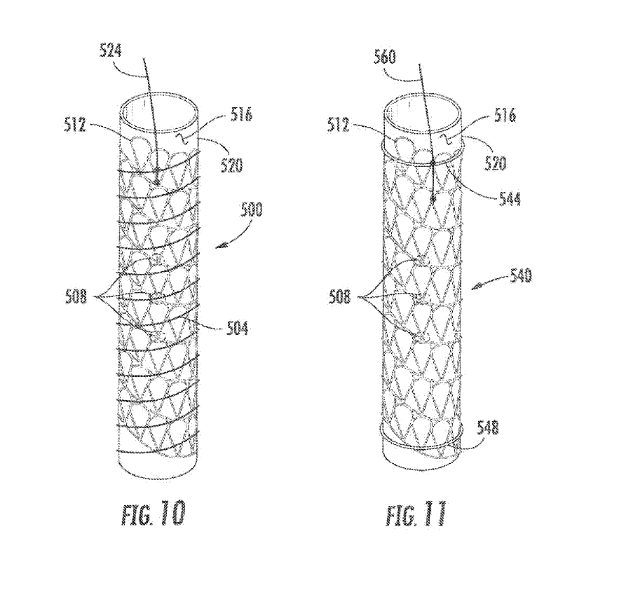

FIG. 7 illustrates an assembly operation where a pulling assembly force 350 may be used to pull the tubular conductive wire mesh 316 into the interior portion 304 of the tubular fuel cell body 300. An inside surface 308 of an exemplary fuel cell body 300 can be a porous support tube, an electrode, such as a porous anode or porous cathode, or any other component of a tubular fuel cell body 300.

In embodiments where a tubular conductive wire mesh is installed inside a tubular fuel cell body, e.g., in direct and/or electrical contact with a tubular electrode layer, a seating force may be applied to press the tubular conductive wire mesh against the interior surface of the tubular fuel cell body. The seating force may be applied by a separate seating element or, as previously indicated, the seating force may be applied by a resilience of the tubular conductive wire mesh. The purpose of the seating force is to establish that a substantial portion of the junctions of the tubular conductive wire mesh are disposed in contact with the inside surface of the tubular fuel cell body. After seating, the tubular conductive wire mesh may be bonded to the inside surface of the tubular fuel cell body. Exemplary bonding materials include, but are not limited to, perfluorinated resins, such as those sold by E. I. Du Pont De Nemours and Company (“DuPont”) under the TEFLON mark, and perfluorinated sulfonic acid resins, such as those sold by DuPont under the NAFION mark, those sold by Dow Chemical under the DOW mark, those sold by Asahi Glass under the FLEMION mark, those sold by Asahi Chemical under the ACIPLEX mark, and any suitable perfluorinated sulfonic acid resin substitute.

FIG. 8 depicts an element for a solid state electrochemical device 360 and illustrates an example of how a separate seating element, spring 364, may be used to apply a seating force to a tubular conductive wire mesh 368 that is installed inside a tubular fuel cell body 300. In practice the spring 364 is a continuous spiral spring and the tubular fuel cell body 300 and the tubular conductive wire mesh 368 are full cylindrical shapes. However, in FIG. 8 portions of the spring 364 and the tubular fuel cell body 300 and the tubular conductive wire mesh 368 are cut-away to simplify the illustration. The tubular conductive wire mesh 368 is formed with loose segments and has a plurality of junctions 372. The spring 364 presses the majority or nearly all (e.g., >80%, >90%, >95% or even >99%) of the junctions 372 into contact with the inside surface 308 of the tubular fuel cell body 300. The inside surface 308 of an exemplary fuel cell body 300 can be a porous support tube, an electrode, such as a porous anode or porous cathode, or any other component of a tubular fuel cell body 300.

FIG. 8 also illustrates an electrical lead wire 376 that is electrically connected to the tubular conductive wire mesh 368 via a first spot weld 380. In the embodiment of FIG. 8 the spring 364 is electrically conductive and the spring 364 is in electrical contact with the tubular conductive wire mesh 368. Furthermore, the electrical lead wire 376 is electrically connected to the spring 364 by a second spot weld 384. In some embodiments only one of the first spot weld 380 and the second spot weld 384 may be employed. In some embodiments the first spot weld 380 and/or the second spot weld 384 may be replaced with a soldered connection, a brazed connection, or a mechanical connection. The electrical lead wire 376 conducts electrical current to or from the element 360, depending upon the configuration of the solid state electrochemical device 360.

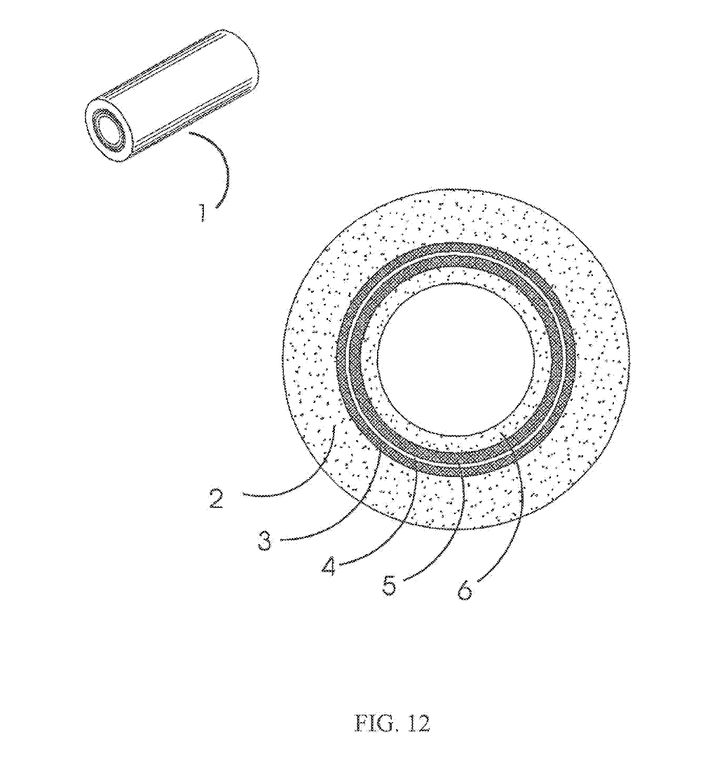

FIG. 9 depicts an element for a solid state electrochemical device 400 and illustrates how a different seating element (a first plug 404 and a second plug 408) may be used to apply a seating force to a tubular conductive wire mesh 368 that is installed inside a tubular fuel cell body 300. In practice the tubular fuel cell body 300 and the tubular conductive wire mesh 368 are full cylindrical shapes, but in FIG. 9 portions of the tubular fuel cell 300 and the tubular conductive wire mesh 368 are cut-away to simplify the illustration. The plugs 404 and 408 are sized to be pushed into the tubular fuel cell 300 and engage the tubular conductive wire mesh 368 (which is mesh formed with loose segments and has a plurality of junctions 372) with a longitudinal compressive force that expands the diameter of the tubular conductive wire mesh 368 and presses the majority or nearly all (e.g., >80%, >90%, >95% or even >99%) of the junctions 372 of the tubular conductive wire mesh 368 into contact with the inside surface 308 of the tubular fuel cell body 300. FIG. 9 also illustrates an electrical lead wire 412 that is electrically connected to the tubular conductive wire mesh 368 via a first spot weld 416. In the embodiment of FIG. 9 the first plug 404 is electrically conductive and the first plug 404 is in electrical contact with the tubular conductive wire mesh 368. Furthermore, the electrical lead wire 412 is electrically connected to the first plug 404 by a second spot weld 420. In some embodiments only one of the first spot weld 416 and the second spot weld 420 may be employed. In some embodiments the first spot weld 416 and/or the second spot weld 420 may be replaced with a soldered connection, a brazed connection, or a mechanical connection. The electrical lead wire 408 conducts electrical current to or from the solid state electrochemical device 400, depending upon the configuration of the solid state electrochemical device 400.

In some embodiments the first plug 404 of the solid state electrochemical device 400 of FIG. 9 is configured as an electrically conductive sleeve that extends beyond the end of the tubular fuel cell body 300. In such embodiments the first plug 404 (configured as a sleeve extending beyond the end of the tubular fuel cell body 300) is used to conduct electrical current to or from the solid state electrochemical device 400, depending upon the configuration of the solid state electrochemical device 400 in which the tubular fuel cell body 300 is employed. The electrical wire leads 376 (of FIG. 8) and 412 (of FIG. 9) and the first plug 404 (of FIG. 9) when configured as an electrically conducive sleeve that extends beyond the end of the tubular fuel cell body 300 are examples of electrical terminals that may be used to establish an electrical connection to the tubular wire mesh 368 to conduct electrical current to or from the solid state electrochemical device 360 (FIG. 8) or 400 (FIG. 9), depending upon the configuration of the solid state electrochemical device in which the solid state electrochemical device (360 or 400) is employed. In some embodiments a portion of the tubular wire mesh 368 may comprise an electrical terminal connection for establishing an electrical connection to the tubular wire mesh 368 to conduct electrical current to or from the solid state electrochemical device 360 or 400. In such embodiments the portion of the tubular wire mesh 368 that comprises the electrical terminal connection typically extends beyond an end of the solid state electrochemical device 360 or 400.

FIGS. 6-9 are generalized to show only a single layer for the tubular fuel cell body 300, of the solid state electrochemical device. However, it should be understood that the tubular fuel cell body 300 can include multiple layers, including, but not limited to, porous support members, electrodes, i.e., anodes and cathodes, and dense electrolytes. Furthermore, it should be understood, that the inner surface 308 of the tubular fuel cell body 300 can be the innermost layer of the tubular fuel cell body, e.g., a porous support member or an electrode, such as a porous anode or porous cathode. Exemplary fuel cell bodies include, but are not limited to, those shown in FIGS. 12 & 13, as well as, the fuel cell bodies shown in U.S. Pat. No. 7,785,747, issued Sep. 31, 2010; U.S. Patent Application Publication No. 2007-0141424 published Jun. 21, 2007; U.S. Pat. No. 7,758,993 issued Jul. 20, 2010; U.S. Patent Application Publication No. 2007-0237998 published Oct. 11, 2007; and U.S. Patent Application Publication No. 2008-0254335 published Oct. 16, 2008, the entireties of which are hereby incorporated by reference.

Other embodiments include methods for fabricating an element for a solid state electrochemical device 500 that incorporates a tubular fuel cell body 520 having an outside surface 516. In such methods a tubular conductive wire mesh 512 may be selected where the mesh has a longitudinal compressive yield strength, a maximum insertion diameter, and a plurality of junctions. The mesh may be further selected such that the tubular conductive wire mesh 512 (i) is expandable to an expanded diameter that is greater than the outside diameter of the tubular fuel cell body 520 by applying a longitudinal compressive force to the tubular conductive wire mesh that is less than the longitudinal compressive yield strength and (ii) is contractible to a contracted diameter that is substantially equal to the outside diameter of the tubular fuel cell body 520 by applying a, seating force. Generally in such embodiments, if the maximum insertion diameter of the tubular wire mesh 512 is less than the outside diameter of the tubular fuel cell body 520, then the longitudinal-compressive force is applied to the tubular conductive wire mesh in order to expand the inside diameter of the tubular wire mesh. The mesh 512 may be assembled over the outside surface 516 of the tubular fuel cell body 520 by applying a longitudinal assembly force to the tubular conductive wire mesh 512. If the longitudinal compressive force was applied, then a further step is removing the longitudinal compressive force from the tubular conductive wire mesh 512. Generally the method further includes applying a seating force to the tubular conductive wire mesh 512, wherein the majority or nearly all (e.g., >80%, >90%, >95% or even >99%) of the junctions 508 of the tubular conductive wire mesh 512 are disposed in contact with the outside surface 516 of the tubular fuel cell body 520. After seating, the tubular conductive wire mesh 512 may be bonded to the outside surface 516 of the tubular fuel cell body 520. Exemplary bonding materials include, but are not limited to, perfluorinated resins and perfluorinated sulfonic acid resins.

In embodiments where a tubular conductive wire mesh 512 is installed over the outside surface 516 of a tubular fuel cell body 520, such as depicted with solid state electrochemical device 500 in FIG. 10 or solid state electrochemical device 540 of FIG. 11, a seating force may be applied to press the tubular conductive wire mesh 512 against the outside surface 516 of the tubular fuel cell body 520. In FIG. 10 the seating force is applied by a separate seating element, a spring 504, which compresses a plurality of junctions 508 of a tubular conductive wire mesh 512 against the outside surface 516 of a tubular fuel cell body 520. An electrical lead wire 524 is electrically connected to the tubular conductive wire mesh 512 and to the spring 504 in a manner analogous to the connection of the electrical wire lead 376 to the tubular conductive mesh 368 and spring 364 of FIG. 8.

In FIG. 11 a first ring 544 and a second ring 548 apply opposing longitudinal forces to the tubular conductive wire mesh 508 to stretch the tubular conductive wire mesh 508 taut against the outside surface 516 of the tubular fuel cell body 520. The opposing longitudinal forces provided by the two rings 544 and 548 are generated by longitudinally stretching the tubular conductive wire mesh 512 over the outside surface 516 of the tubular fuel cell body 520 to a length greater than its free-state length and then applying the two rings 544 and 548 over the tubular conductive wire mesh 512 to maintain the tubular wire mesh 512 in the stretched position and prevent the tubular wire mesh 512 from contracting back to its free-state length. Alternately, the seating force for the tubular conductive wire mesh 512 of FIG. 10 or FIG. 11 may be applied by a resilience of the tubular conductive wire mesh 512. The purpose of the seating force is to establish that the majority or nearly all of the junctions 508 of the tubular conductive wire mesh 512 contact the outside surface 516 of the tubular fuel cell body 520. FIG. 11 also illustrates an electrical lead wire 560 that is electrically connected to the tubular conductive wire mesh 512 and to the first ring 544 in a manner analogous to the connection of the electrical wire lead 412 to the tubular conductive wire mesh 368 and the first plug 404 of FIG. 9.

In some embodiments the first ring 544 of the solid state electrochemical device 540 of FIG. 11 is used to conduct electrical current to or from the element 400, depending upon the configuration of the solid state electrochemical device in which the element 400 is employed. The electrical wire lead 524 (of FIG. 10) and the first ring 544 (of FIG. 11) are examples of electrical terminals that may be used to conduct electrical current to or from the element 360 (FIG. 8) or 400 (FIG. 9), depending upon the configuration of the solid state electrochemical device in which the element (500 or 540) is employed.

FIGS. 10 & 11 are generalized to show only a single layer for the tubular fuel cell body 520, of the solid state electrochemical device 500 and 540 for FIGS. 10 & 11, respectively. However, it should be understood that the tubular fuel cell body 520 can include multiple layers, including, but not limited to, porous support members, electrodes, i.e., anodes and cathodes, and dense electrolytes. Furthermore, it should be understood, that the outside surface 516 of the tubular fuel cell body 520 can be the outsidemost layer of the tubular fuel cell body, e.g., a porous support member or an electrode, such as a porous anode or porous cathode. Exemplary fuel cell bodies include, but are not limited to, those shown in FIGS. 12 & 13, as well as, the fuel cell bodies shown in U.S. Pat. No. 7,785,747, issued Sep. 31, 2010; U.S. Patent Application Publication No. 2007-0141424 published Jun. 21, 2007; U.S. Pat. No. 7,758,993 issued Jul. 20, 2010; U.S. Patent Application Publication No. 2007-0237998 published Oct. 11, 2007; and U.S. Patent Application Publication No. 2008-0254335 published Oct. 16, 2008, the entireties of which are hereby incorporated by reference.

FIG. 12 shows details of an exemplary layered structure that may be present in the tubular fuel cell bodies shown in FIGS. 4-11. The tubular fuel cell body 1 of FIG. 12 includes a porous, sintered metallic support tube 2, a first porous electrode 3 (cathode or anode), a dense electrolyte layer 4, a second porous electrode 5 (anode or cathode), and a second porous, sintered tubular member 6. The potential compositions and properties of these layers can be found herein and in U.S. Patent Application Publication No. 2008/0254335 published Oct. 16, 2008.

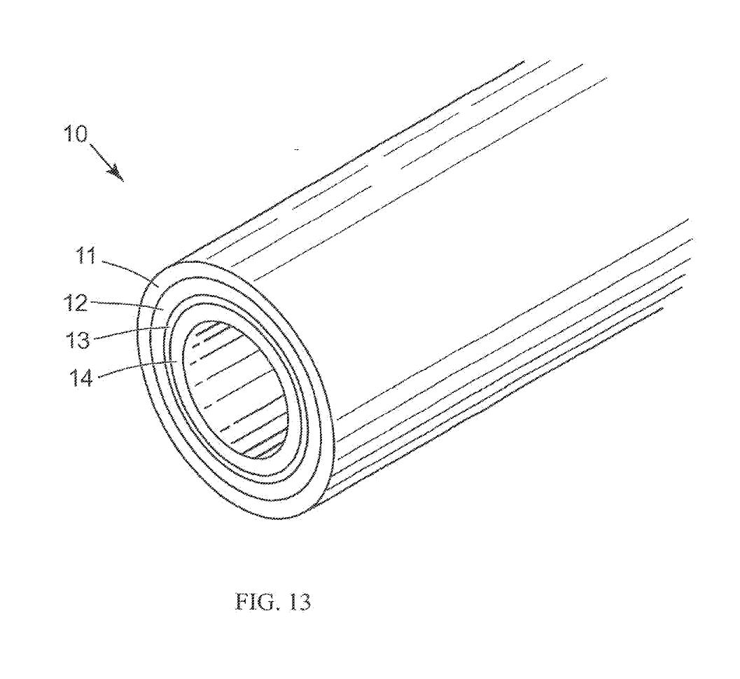

FIG. 13 shows details of another exemplary layered structure that may be present in the tubular fuel cell bodies shown in FIGS. 4-11. The tubular fuel cell body 10 of FIG. 13 includes a porous, sintered metallic support tube 11, a first porous electrode 12 (cathode or anode), a dense electrolyte layer 13 and a second porous electrode 14 (anode or cathode). The potential compositions and properties of these layers can be found herein and in U.S. Patent Application Publication No. 2007/0237998 published Oct. 11, 2007.

### EXAMPLE

A sample fuel cell conductive wire mesh was fabricated in the knit mesh pattern of FIG. 2 using a wire knitting device that is available from ACS Industries, Inc., 1 New England Way, Lincoln, R.I. 02865. The knit mesh had the following configuration (with all dimensions in inches).

Wire Diameter: 0.010

Number of Loops in circumference: 22

Maximum pitch angle: 25°

Loop aspect ratio: 2

Elliptical aspect ratio: 1.2

The fuel cell conductive wire mesh had the following properties:

| | Free- | Compressed | | % | Stretched | | % |
|---|---|---|---|---|---|---|---|
| | state | State | Difference | Change | State | Difference | Change |
| Length | 1.35 | 1.01 | 0.34 | 25% | 1.48 | 0.13 | 10% |
| Outside | 0.37 | 0.38 | 0.01 | 3% | 0.37 | 0 | 0% |
| Diameter at | | | | | | | |
| Junctions | | | | | | | |
| Inside | 0.35 | 0.36 | 0.01 | 3% | 0.35 | 0 | 0% |
| Diameter at | | | | | | | |
| Junctions | | | | | | | |

In summary, embodiments disclosed herein provide various tubular conductive wire mesh configurations and methods for assembling tubular conductive wire meshes with tubular electrodes. The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

1. A solid state electrochemical device comprising:
a tubular fuel cell body having an external surface; and
a tubular conductive wire mesh in electrical communication with said external surface, wherein said tubular conductive wire mesh comprises has a maximum insertion diameter, a minimum envelope diameter, a longitudinal compressive yield strength, and a longitudinal tensile yield strength,
wherein under a longitudinal compressive force that does not exceed the longitudinal compressive strength of the conductive wire mesh, the conductive wire mesh is expandable to an expanded inside diameter that is larger than the maximum insertion diameter, and
wherein under a longitudinal tensile force that does not exceed the longitudinal tensile strength of the mesh, the conductive wire mesh is contractible to a contracted outside diameter that is less than the minimum envelope diameter.

2. The solid state electrochemical device according to claim 1, wherein said tubular conductive wire mesh comprises:
a conductive wire forming a knit mesh having a series of adjacent substantially uniform interconnected generally triangular loops, each generally triangular loop having a base portion and a tip portion, the conductive wire extending from the tip portion of a generally triangular first loop through the base portion of a longitudinally adjacent generally triangular second loop to form a junction, the conductive wire further forming the base portions of generally triangular third and fourth loops that are laterally adjacent the first loop.

3. The solid state electrochemical device according to claim 1, wherein said tubular conductive wire mesh comprises a plurality of conductive wires that are woven together to form (a) a plurality of cells and (b) a plurality of junctions where the conductive wires overlap.

4. The solid state electrochemical device according to claim 1, wherein the wire mesh has a cylindrical free-state configuration.

5. The solid state electrochemical device according to claim 1 wherein the knit mesh has a cylindrical free-state configuration.

6. The solid state electrochemical device according to claim 1 wherein multiple junctions form a spiral pattern in the knit mesh.

7. The solid state electrochemical device according to claim 1 wherein the generally triangular loops have a loop aspect ratio that is in a range from about 1 to about 3.

8. The solid state electrochemical device according to claim 1, further comprising a binder or separate seating element coupling said external surface and said tubular conductive wire mesh.

9. The solid state electrochemical device according to claim 1, wherein said external surface is an interior or exterior surface of said tubular fuel cell body.

10. The solid state electrochemical device according to claim 1, further comprising a second tubular conductive wire mesh, wherein said external surface is an interior surface of said tubular fuel cell body, and wherein said second tubular conductive wire mesh is in electrical communication with an outside surface of said tubular fuel cell body.

11. A non-rigid tubular conductive wire mesh having a maximum insertion diameter, a minimum envelope diameter, a longitudinal compressive yield strength, and a longitudinal tensile yield strength, wherein:
under a longitudinal compressive force that does not exceed the longitudinal compressive strength of the conductive wire mesh, the conductive wire mesh is expandable to an expanded inside diameter that is larger than the maximum insertion diameter, and wherein
under a longitudinal tensile force that does not exceed the longitudinal tensile strength of the mesh, the conductive wire mesh is contractible to a contracted outside diameter that is less than the minimum envelope diameter.

12. A method for fabricating an element for a solid state electrochemical device comprising a tubular fuel cell body having an interior portion with an inside surface and an inside diameter, comprising:
(a) selecting a tubular conductive wire mesh having a maximum envelope diameter, a longitudinal tensile yield strength and a plurality of junctions, wherein the tubular conductive wire mesh (i) is constrictable to a constricted diameter that is substantially no more than the inside diameter of the tubular electrode by applying to the tubular conductive wire mesh a longitudinal stretching force that is less than the longitudinal tensile yield strength, and (ii) is expandable to an expanded diameter that is substantially equal to the inside diameter of the tubular fuel cell body by applying a seating force;
(b) if the maximum envelope diameter of the tubular conductive wire mesh is greater than the inside diameter of the tubular electrode, then applying the longitudinal stretching force to the tubular conductive wire mesh;
(c) applying a longitudinal assembly force to the tubular conductive wire mesh to insert the tubular conductive wire mesh into the interior portion of the tubular fuel cell body; and
(d) if the longitudinal stretching force was applied in step (b), then removing the longitudinal stretching force from the tubular conductive wire mesh;
(e) removing the longitudinal assembly force from the tubular conductive wire mesh;
(f) applying a seating force to the tubular conductive wire mesh, wherein a substantial portion of the junctions of the tubular conductive wire mesh are disposed in contact with the inside surface of the tubular fuel cell body; and
(g) establishing an electrical connection to the tubular conductive wire mesh.

13. The method of claim 12 wherein the longitudinal assembly force comprises a pulling force.

14. The method of claim 12 wherein the longitudinal force comprises a pushing force.

15. A method for fabricating an element for a solid state electrochemical device comprising a tubular fuel cell body having an exterior surface with an outside diameter, comprising:
(a) selecting a tubular conductive wire mesh having a longitudinal compressive yield strength, a maximum insertion diameter, and a plurality of junctions, wherein the tubular conductive wire mesh (i) is expandable to an expanded diameter that is greater than the outside diameter of the tubular electrode by applying a longitudinal compressive force to the tubular conductive wire mesh that is less than the longitudinal compressive yield strength and (ii) is contractible to a contracted diameter that is substantially equal to the outside diameter of the tubular electrode by applying a seating force;
(b) if the maximum insertion diameter of the tubular wire mesh is less than the outside diameter of the tubular fuel cell body, then applying the longitudinal compressive force to the tubular conductive wire mesh;
(c) applying a longitudinal assembly force to the tubular conductive wire mesh to apply the conductive wire mesh over the exterior surface of the tubular fuel cell body;
(d) if the longitudinal compressive force was applied in step (b), then removing the longitudinal compressive force from the tubular conductive wire mesh;
(e) applying a seating force to the tubular conductive wire mesh, wherein a substantial portion of the junctions of the tubular conductive wire mesh are disposed in contact with the outside surface of the tubular fuel cell body; and
(f) establishing an electrical connection to the tubular conductive wire mesh.

16. The method of claim 15 wherein the longitudinal assembly force comprises a pushing force.

17. The method of claim 15 wherein the longitudinal assembly force comprises a pulling force.

18. A tubular conductive wire mesh for use in a solid state electrochemical device comprising a plurality of conductive wires that are woven together to form (a) a plurality of cells and (b) a plurality of junctions where the conductive wires overlap.

19. The tubular conductive wire mesh of claim 18 wherein the wire mesh has a cylindrical free-state configuration.

20. A tubular conductive wire mesh for use in a solid state electrochemical device comprising
a conductive wire forming a knit mesh having a series of adjacent substantially uniform interconnected generally triangular loops, each generally triangular loop having a base portion and a tip portion, the conductive wire extending from the tip portion of a generally triangular first loop through the base portion of a longitudinally adjacent generally triangular second loop to form a junction, the conductive wire further forming the base portions of generally triangular third and fourth loops that are laterally adjacent the first loop.
